(19) United States
(12) Patent Application Publication
(10) Pub. No.: US 2021/0116016 A1
(43) Pub. Date: Apr. 22, 2021

(54) THERMOSTATICALLY CONTROLLED EMERGENCY LUBRICATION SYSTEM

(71) Applicant: Bell Textron Inc., Fort Worth, TX (US)

(72) Inventor: Douglas Robert MUELLER, Coppell, TX (US)

(73) Assignee: Bell Textron Inc., Fort Worth, TX (US)

(21) Appl. No.: 16/657,331

(22) Filed: Oct. 18, 2019

(51) Int. Cl. F16H 57/04; F16N 29/02; B64D 35/00

(52) U.S. Cl. CPC F16H 57/0442; F16H 57/0441; F16H 57/0456; F16H 57/045; F16H 57/0412; B64D 35/00; F16N 2210/08; F16N 2270/70; F16N 2280/00; F16N 29/02

(57) ABSTRACT

A lubrication system includes a primary lubrication system for a gearbox of the aircraft, the primary lubrication system comprising a first lubricant tank, and an emergency lubrication system for the gearbox. The emergency lubrication system includes a second lubricant tank coupled to a gearbox of an aircraft, a passive thermostat coupled between the second lubricant tank and the gearbox via a lubricant line, a conductor coupled between the passive thermostat and the gearbox and configured to conduct heat from the gearbox to the passive thermostat, and wherein the passive thermostat is configured to open in response to the conductor being exposed to a temperature that exceeds a threshold temperature.

### TECHNICAL FIELD

This invention relates generally to a rotorcraft, and more particularly, to an emergency lubrication system for rotorcraft gearboxes.

### BACKGROUND

Rotorcraft drive systems can include various components that produce and transfer power. For example, engines and gearboxes are standard components. Such components generate heat and require lubrication. Excessive levels of heat can cause premature failure and create safety risks. Proper lubrication serves to reduce heat generation and assist in heat removal from moving components within gearboxes.

Typically, rotorcraft use a variety of primary lubrication systems to provide wear protection and heat transfer for moving components. Under normal operating conditions, primary lubrication systems provide proper lubrication and heat removal. However, in the event of a failure of the primary lubrication systems, excessive heat is generated that causes wear and/or failure of components, such as bearings or gears within a gearbox.

Rotorcraft are generally required to maintain manageable flight operations for selected durations of time if the primary lubrication system fails. One method used to satisfy the requirements of manageable flight during a lubrication system failure is to use a secondary, emergency lubrication system to operate when the primary lubrication system fails.

### SUMMARY

An example of an emergency lubrication system includes: a lubricant tank coupled to a gearbox of an aircraft, a passive thermostat coupled between the lubricant tank and the gearbox via a lubricant line, a conductor coupled between the passive thermostat and the gearbox and configured to conduct heat from the gearbox to the passive thermostat, and wherein the passive thermostat is configured to open in response to the conductor being exposed to a temperature that exceeds a threshold temperature.

An example of a lubrication system includes: a primary lubrication system for a gearbox of the aircraft, the primary lubrication system comprising a first lubricant tank, and an emergency lubrication system for the gearbox. The emergency lubrication system includes a second lubricant tank coupled to a gearbox of an aircraft, a passive thermostat coupled between the second lubricant tank and the gearbox via a lubricant line, a conductor coupled between the passive thermostat and the gearbox and configured to conduct heat from the gearbox to the passive thermostat, and wherein the passive thermostat is configured to open in response to the conductor being exposed to a temperature that exceeds a threshold temperature.

An example method of providing passive emergency lubrication for an aircraft includes conducting heat from a gearbox of the aircraft to a passive thermostat via a conductor that is coupled between the passive thermostat and the gearbox. Responsive to a temperature of the passive thermostat exceeding a threshold temperature, opening the passive thermostat to allow a lubricant to flow from a lubricant tank to the gearbox via a lubricant line. Providing the lubricant via the lubricant line to the gearbox from the lubricant tank.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 shows a perspective view of a tiltrotor aircraft in helicopter mode, according to aspects of the disclosure;

FIG. 2 shows a perspective view of a tiltrotor aircraft in airplane mode, according to aspects of the disclosure;

FIG. 3 is a perspective view of a drive system of an exemplary tiltrotor aircraft, according to aspects of the disclosure;

FIG. 4 is a schematic view of a lubrication arrangement of an exemplary tiltrotor drive system, according to aspects of the disclosure;

FIG. 5 is a sectioned view of a gearbox of the lubrication arrangement of FIG. 4, according to aspects of the disclosure; and

FIGS. 6A and 6B are illustrative views of a thermostat for use with an emergency lubrication system, according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

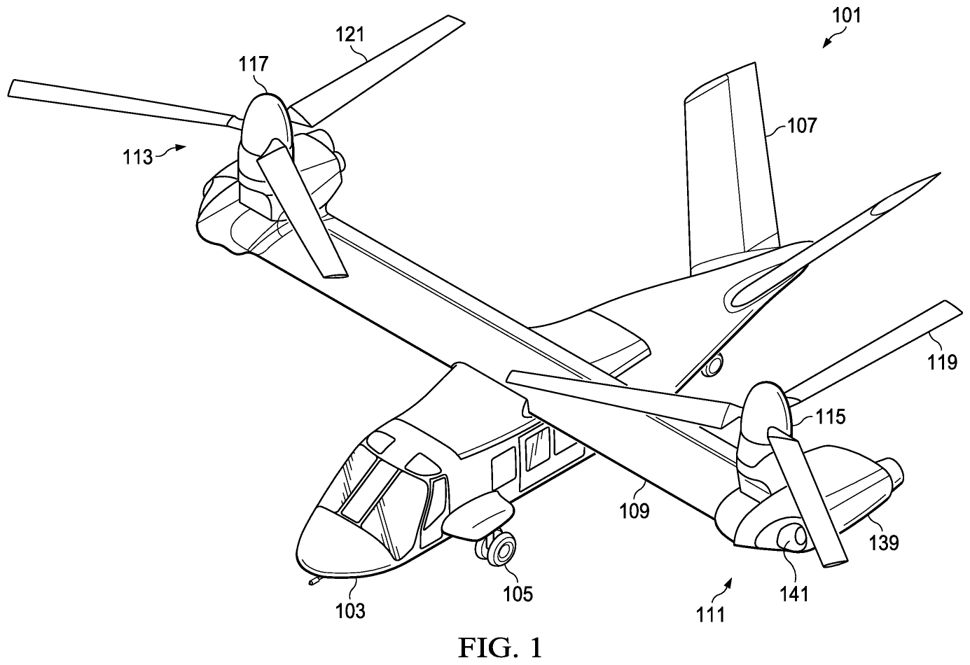

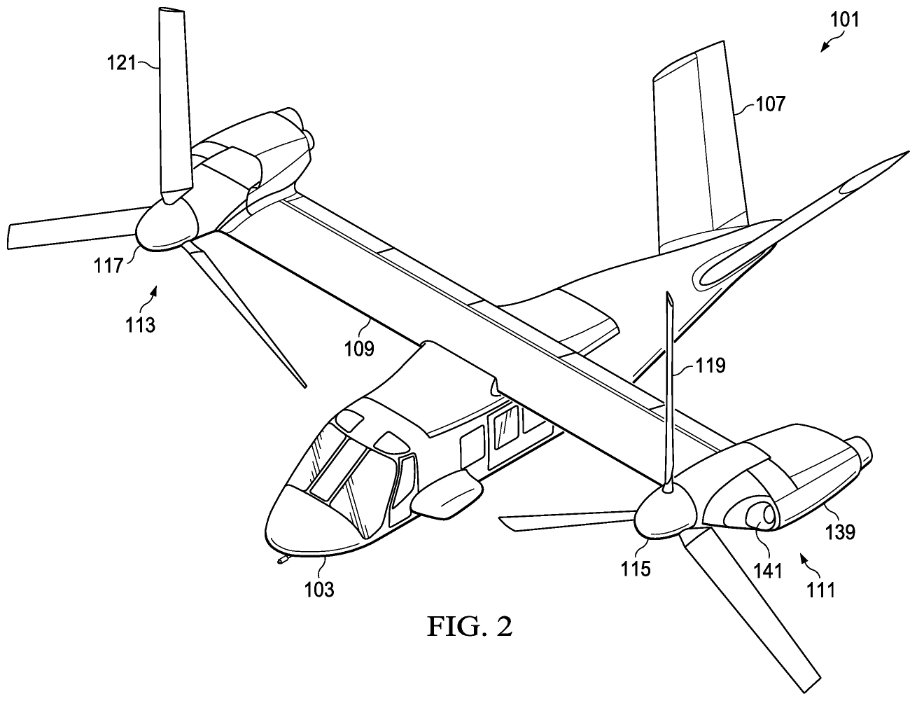

FIGS. 1 and 2 in the drawings illustrate a tiltrotor aircraft 101, according to aspects of the disclosure. Tiltrotor aircraft 101 includes a fuselage 103, a landing gear 105, a tail member 107, a wing 109, a drive system 111, and a drive system 113. Each drive system 111 and 113 includes a fixed engine 139 and a rotatable proprotor 115 and 117, respectively. Each of rotatable proprotors 115 and 117 has a plurality of rotor blades 119 and 121, respectively, associated therewith. The position of proprotors 115 and 117, as well as the pitch of rotor blades 119 and 121, can be selectively controlled in order to selectively control direction, thrust, and lift of tiltrotor aircraft 101.

FIG. 1 illustrates tiltrotor aircraft 101 in helicopter mode, in which proprotors 115 and 117 are positioned substantially vertical to provide a lifting thrust. FIG. 2 illustrates tiltrotor aircraft 101 in an airplane mode in which proprotors 115 and 117 are positioned substantially horizontal to provide a forward thrust in which a lifting force is supplied by wing 109. It should be appreciated that tiltrotor aircraft 101 can be operated such that proprotors 115 and 117 are selectively positioned between airplane mode and helicopter mode, which can be referred to as a conversion mode.

The drive system 113 is substantially symmetric to the drive system 111; therefore, for sake of efficiency, certain features will be disclosed only with regard to drive system 111. However, one of ordinary skill in the art would fully appreciate an understanding of drive system 113 based upon the disclosure herein of drive system 111. Further, drive systems 111 and 113 are illustrated in the context of tiltrotor aircraft 101; however, drive systems 111 and 113 can be implemented on other tiltrotor aircraft. For example, an alternative embodiment may include a quad tiltrotor that has an additional wing member aft of wing 109; the additional wing member can have additional drive systems similar to drive systems 111 and 113. In another embodiment, drive systems 111 and 113 can be used with an unmanned version of tiltrotor aircraft 101. Further, drive systems 111 and 113 can be integrated into a variety of tiltrotor aircraft configurations. Additionally, other drive systems are contemplated. For example, one example is a gearbox arrangement to provide torque to a rotor system of a helicopter.

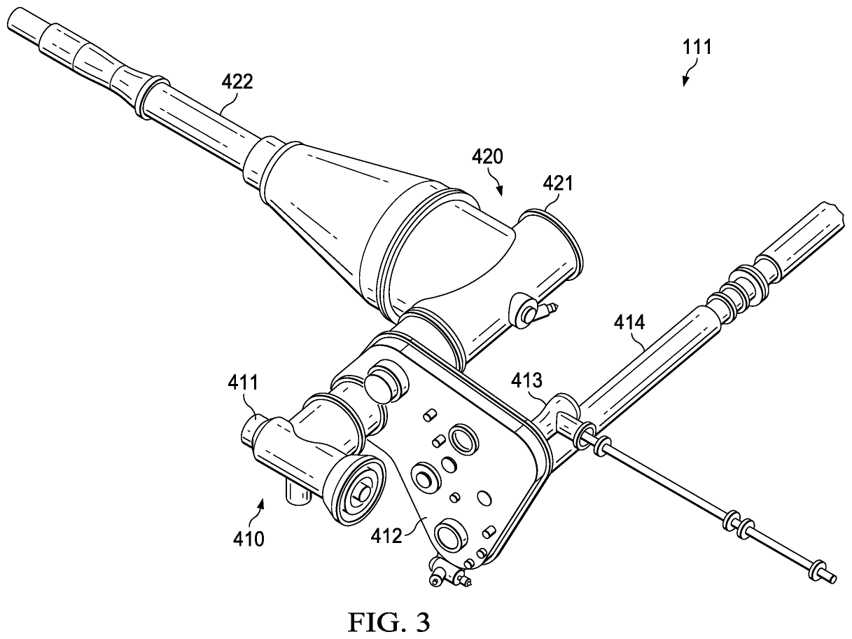

FIG. 3 shows a perspective view of drive system 111, according to one example embodiment. Drive system 111 may include a first gearbox assembly 410 and a second gearbox assembly 420. First gearbox assembly 410 may include spiral bevel gearbox 411, interconnect gearbox 412, blower gearbox 413, interconnect driveshaft 414, and engine 139 (not shown in FIG. 3). Second gearbox assembly 420 may include proprotor gearbox 421, and mast 422.

Engine 139 may be fixed relative to wing 109 of tiltrotor aircraft 101 and can provide torque via an engine output shaft to spiral bevel gearbox 411. Spiral bevel gearbox 411 can include spiral bevel gears to change torque direction by approximately ninety degrees from engine 139 to interconnect gearbox 412 via a clutch. Interconnect gearbox 412 can include a plurality of gears, such as helical gears, in a gear train that are coupled to interconnect driveshaft 414, blower gearbox 413, and second gearbox assembly 420. The interconnect gearbox 412 can also be configured to provide power to various system accessories such as alternators, lube and scavenge pumps, hydraulic pumps, and generators.

Proprotor gearbox 421 includes a plurality of gears that are configured to transfer power and reduce rotational speed to mast 422. Blower gearbox 413 is mounted to interconnect gearbox 412 and is configured to provide torque to the oil cooler blower fan, which draws in air for lubricant temperature reduction. Interconnect driveshaft 414 provides a torque path that enables a single engine to provide torque to both drive systems 111 and 113 in the event of a failure of one of the engines.

Gears, bearings, and other mechanical components of drive system 111 are subject to wear and heat generation due to contact with other components. These mechanical components may be lubricated to reduce friction and transfer heat away from the components. Lubrication is the process or technique employed to reduce wear of one or both surfaces in close proximity, and moving relative to each other, by interposing a substance, such as a lubricant, between the surfaces to help carry the load (pressure generated) between the opposing surfaces. A lubricant is a substance introduced to reduce friction between moving surfaces. Examples of lubricants include oil, biolubricants derived from plants and animals, synthetic oils, solid lubricants, and aqueous lubricants. Example transmission oils for proprotor gearbox 421 may include oils meeting specifications MIL-PRF-23699 (5 cSt), DOD-L-7808 (3-4 cSt), DOD-PRF-85734 (5 cSt), and other oils in the 9 cSt to 10 cSt viscosity range. Drive system 111 may include one or more lubrication systems to provide lubricant to the mechanical components of drive system 111.

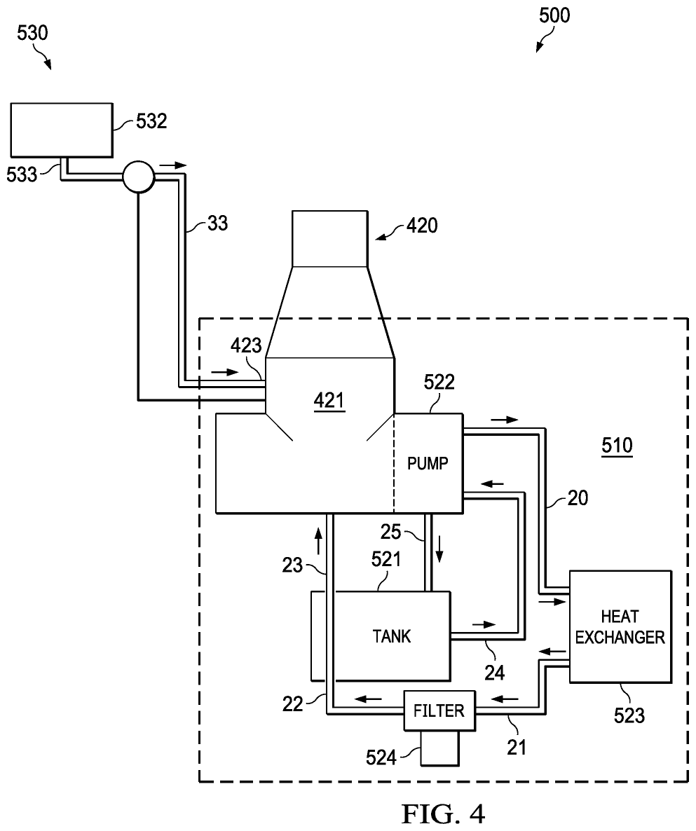

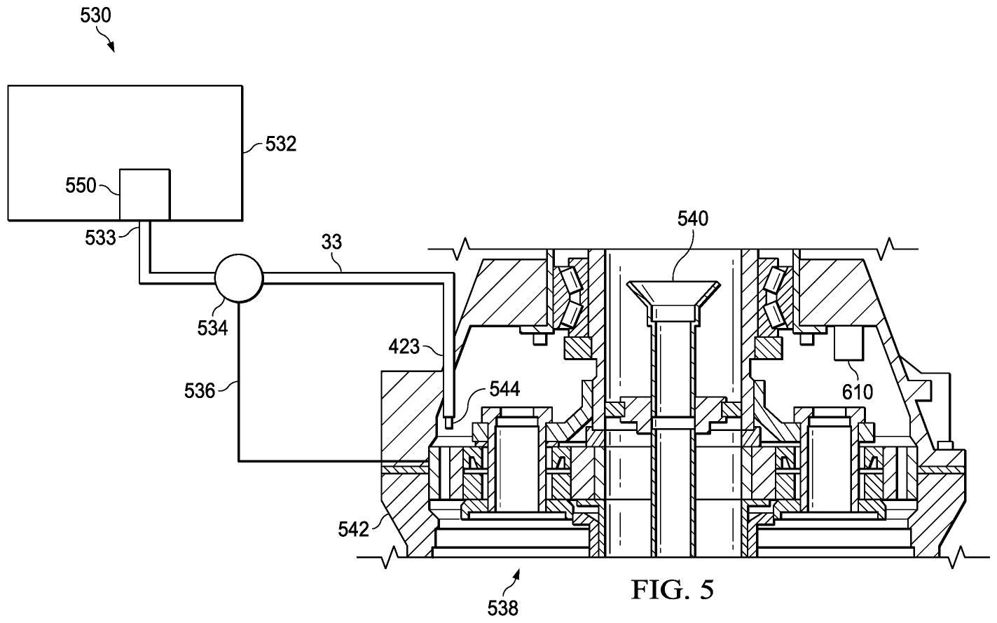

FIGS. 4 and 5 illustrate an emergency lubrication system 530 for use with a lubrication arrangement 500a. FIG. 4 is a schematic view of lubrication arrangement 500a, according to aspects of the disclosure. FIG. 5 is sectioned view of second gearbox assembly 420 of FIG. 4. Lubrication arrangement 500a includes a primary lubrication system 510 and an emergency lubrication system 530. Primary lubrication system 510 provides lubricant to components of second gearbox assembly 420. Primary lubrication system 510 includes a lubricant tank 521, a pump 522, a heat exchanger 523, a filter 524, and lubrication lines 20 through 25. Primary lubrication system 510 may also include other components such as one or more sensors 610 (FIG. 5), pressure regulators, flowmeters, check valves, and jets.

Lubricant tank 521 represents reservoirs that store lubricant within primary lubrication system 510. Lubricant tank 521 may be integral with the housing of one of the gearboxes, such as proprotor gearbox 421, or separate from the housing of proprotor gearbox 421. Pump 522 represents devices that can be configured to circulate pressurized lubricant throughout primary lubrication system 510. Heat exchanger 523 represents devices configured to lower a temperature of the lubricant before the lubricant is applied to the various components that generate heat. Filter 524 represents devices configured to remove contaminants from the lubricant. Jets are configured to dispense lubricant on components of drive system 111 that are subject to friction and/or generate heat, such as gears and bearing.

In some aspects, lubricant arrangement 500a includes one or more sensors 610 (see FIG. 5) that are configured to detect one or more rotorcraft parameters output by tiltrotor aircraft 101. For example, the one or more sensors 610 can include temperature sensors that monitor a temperature of the lubricant, gears, or other components of lubricant arrangement 500a and/or pressure sensors that detect the pressure of the lubricant within primary lubrication system 510. Examples of temperature sensors include thermocouples, resistance-based sensors, and the like. Examples of pressure sensors may include strain-gauge sensors, capacitive sensors, electromagnetic sensors, piezoelectric sensors, optical sensors, potentiometric sensors, resonant sensors, and thermal sensors, and the like.

Lubrication lines 20 through 25 represent fluid lines that connect various components of primary lubrication system 510. Lubrication lines 20 through 25 may comprise rigid pipelines, such as core passages in the housing of a gearbox, or flexible hoses, such as fluoropolymer tubing. The type of lubrication lines used may depend on the location of the line or expected fluid pressure within the line. Lubrication lines 20 through 25 may include other components such as swivels and quick disconnect couplings. In some examples, lubrication lines 20 through 25 may be collapsible in order to reduce residual lubricant during storage and when lubricant is not being flowed through the line.

As mentioned, lubrication lines 20 through 25 may fluidly connect various components of primary lubrication system 510. Lubrication lines 20 through 25 may fluidly connect components of primary lubrication system 510. For example, pump 522 may deliver lubricant from lubricant tank 521 to lubricant line 20, from lubricant line 20 to heat exchanger 523 where the lubricant is cooled. From heat exchanger 523, the lubricant may then be delivered to filter 524, via line 21, where particles may be removed from the lubricant. From filter 524, the lubricant may travel through line 22 to lubricant tank 521.

Under normal operating conditions, primary lubrication system 510 provides proper lubrication to the moving components of second gearbox assembly 420. The lubricant pressure within second gearbox assembly 420 may be at a normal level, for example, fifty PSI (pounds per square inch). If for example, proper lubrication is not provided to the moving components of second gearbox assembly 420 or primary lubrication system 510 experiences a loss of lubrication, the moving components of second gearbox assembly 420 may experience excessive wear, overheating, or failure of components. One example cause of a loss of lubrication may be a leak between the casing of one of the gearboxes and one of its components. In some loss of lubrication circumstances, the lubricant pressure within second gearbox assembly 420 may be reduced to an undesired level. For example, the pressure may drop below thirty PSI, and in some instances may drop to zero PSI. Rotorcraft are generally required to maintain manageable flight operations for selected durations of time if the rotorcraft experiences low lubricant pressure, such as during a loss of lubrication situation or lubrication system failure. For example, an aviation agency may require that a loss of lubrication will not prevent continued safe operation for at least thirty minutes after perception by the flight crew of the lubrication system failure or loss of lubrication. Therefore, some rotorcraft include a secondary or emergency lubrication system, such as emergency lubrication system 530.

Emergency lubrication system 530 includes a secondary lubricant tank 532 that is fluidly coupled to second gearbox assembly 420 via lubrication line 33. In the aspect illustrated in FIGS. 4 and 5, emergency lubrication system 530 includes a thermostat 534 that monitors a temperature of second gearbox assembly 420 via a conductor 536. Conductor 536 extends between second gearbox assembly 420 and thermostat 534 and may be, for example, a metallic wire (e.g., silver, copper, gold, brass, aluminum, etc.), heat pipe, or the like. In some aspects, conductor 536 is thermally insulated to trap the conducted heat within conductor 536 to more efficiently transfer heat from second gearbox assembly 420 to thermostat 534. A distal end of conductor 536 is positioned within second gearbox assembly 420 and conducts heat from the distal end of conductor 536 to thermostat 534. Secondary lubricant tank 532 is a reservoir that stores lubricant for use in emergency conditions. In one aspect, secondary lubricant tank 532 may be configured to contain approximately seven gallons of lubricant. In other aspects, secondary lubricant tank 532 can be sized as needed for a particular application.

In a loss of lubrication event, lubricant is provided from secondary lubricant tank 532 to second gearbox assembly 420 via a gravity feed system. In a gravity feed system, secondary lubricant tank 532 is positioned within tiltrotor aircraft 101 such that an outlet 533 of secondary lubricant tank 532 is at a height that is greater than an inlet 423 of second gearbox assembly 420 to which lubricant line 33 is attached. In other embodiments, secondary lubricant tank 532 optionally includes a pressurizing device 550 configured to provide lubricant to second gearbox assembly 420. Pressurizing device 550 may be, for example, a mechanically driven pump, a hydraulically driven pump, an electrically driven pump, or the like.

Referring now specifically to FIG. 5, second gearbox assembly 420 is shown in partial cross-section. Second gearbox assembly 420 includes a planetary gear/bearing assembly 538 that is coupled to a mast 540. Mast 540 is coupled to and drives a proprotor, such as one of proprotors 115, 117. Planetary gear/bearing assembly 538 is set inside a housing 542. Under normal operating conditions, lubricant from lubricant tank 521 circulates within housing 542 to lubricate planetary gear/bearing assembly 538. In the event of a loss of lubrication event in second gearbox assembly 420, lubricant pressure decreases and gearbox temperature increases. Conductor 536 conducts the increased heat to thermostat 534. In some aspects, thermostat 534 is configured to operate passively. Passive operation is used herein to mean that no manual action by the pilot or automated action by a control system of tiltrotor aircraft 101 is necessary for emergency lubrication system 530 to begin supplying lubricant to second gearbox assembly 420 in the event of a loss of lubrication. For example, as heat is conducted to thermostat 534 by conductor 536, thermostat 534 may reach a threshold temperature. Once thermostat 534 reaches the threshold temperature, thermostat 534 opens automatically based upon temperature and without interaction from the pilot or any additional control system of tiltrotor aircraft 101. By way of example, thermostat 534 may operate similarly to the thermostat of a car.

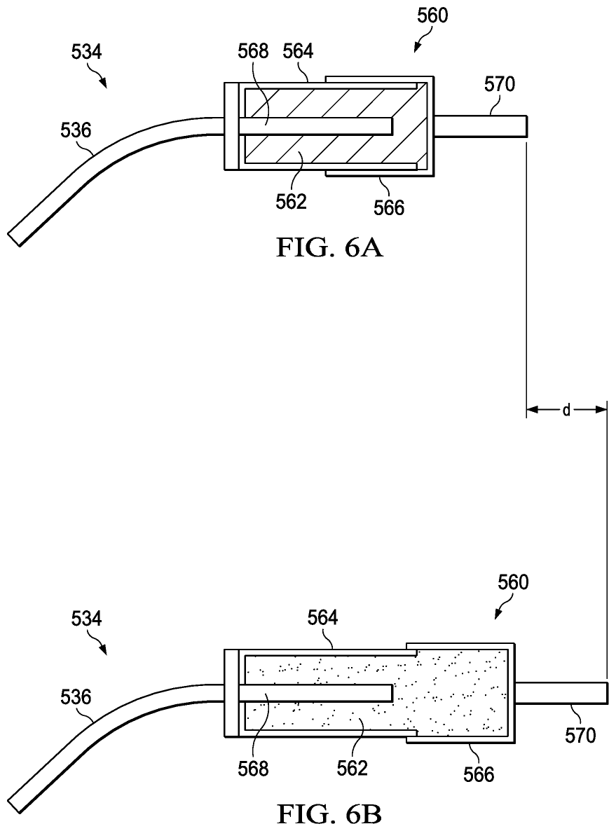

FIGS. 6A and 6B illustrate an exemplary thermostat 534, according to aspects of the disclosure. Thermostat 534 includes a cylinder 560 that is filled with a substance 562 (e.g., wax) that under goes a phase change when a threshold temperature is reached. Cylinder 560 includes a first cylinder 564 and a second cylinder 566 that are movably sealed together so as to retain substance 562 within cylinder 560 while also allowing first and second cylinders 564, 566 to move relative to one another. Conductor 536 is arranged to contact thermostat 534 to conduct heat thereto. As illustrated in FIGS. 6A and 6B, conductor 536 extends into a chamber 568 of first cylinder 564. Chamber 568 extends into first cylinder 564 and provides increased contact between conductor 536 first cylinder 564 to improve the conduction of heat from conductor 536 to substance 562. Once sufficient heat is conducted to substance 562 via conductor 534 (i.e., when second gearbox assembly 420 reaches the threshold temperature as the result of a loss of lubrication event), substance 562 undergoes a phase change from a solid to a liquid. FIG. 6A illustrates substance 562 as a solid and FIG. 6B illustrates substance 562 as a liquid. The phase change of substance 562 from solid to liquid increases the volume of substance 562 within cylinder 560. The increase in volume increases the pressure within cylinder 560, causing second cylinder 566 to move relative to first cylinder 564 to accommodate the increased volume of substance 562. As cylinder 560 expands, a pin 570 attached to second cylinder 566 is also displaced a distance d. The movement of pin 570 may be used to open a valve. For example, as cylinder 560 expands, pin 570 presses against an actuator of a valve within thermostat 534 to open the valve. Thus, when thermostat 534 reaches the threshold temperature, thermostat 534 passively opens as a result of a thermo-mechanical reaction to provide passive/automatic lubrication of second gearbox assembly 420. Thermostat 534 may be any of a variety of other types of passive thermostats.

In some aspects, emergency lubrication system 530 includes a jet 544 affixed to an end of lubrication line 33 that directs the lubricant to a particular location within second proprotor gearbox. For example, FIG. 5 illustrates jet 544 positioned to supply lubricant at an interface between planetary gears and a ring gear of planetary gear/bearing assembly 538. In some aspects, jet 544 disperses lubricant in a spray pattern to provide a wider arear of coverage. If the temperature within second gearbox assembly 420 falls below the threshold temperature, the heat conducted by conductor 536 similarly falls. Once the temperature of thermostat 534 falls below the threshold temperature, thermostat 534 closes and the flow of lubricant from secondary lubricant tank 532 ceases. This passive, automated operation of thermostat 534 is desirable as it prolongs the amount of time emergency lubrication system 530 can supply lubrication to second gearbox assembly 420. For example, if second gearbox assembly 420 develops a leak, emergency lubrication system 530 may become activated. If the leak is slow, emergency lubrication system 530 may provide enough supplemental lubrication that the temperature of second gearbox assembly 420 reduces enough that thermostat 534 closes. Tiltrotor aircraft 101 then continues operation. As more lubricant escapes via the leak, the temperature of second gearbox assembly 420 may again climb and open thermostat 534. Thus, thermostat 534 may passively and automatically cycle between open and closed to supply lubricant as needed in response to temperature fluctuations of second gearbox assembly 420.

In some aspects, thermostat 534 is replaced with an electromechanical valve, such as a solenoid valve or the like. In aspects using a solenoid valve, conductor 536 may be replaced with a sensor, such as pressure or temperature sensor, that monitors second gearbox assembly 420. The sensor is coupled to a controller of the solenoid valve. When the controller determines that a threshold condition has been exceeded (e.g., pressure too low or temperature too high depending on the sensor type), the controller opens the solenoid valve to allow lubricant to flow from secondary lubricant tank 532 to second gearbox assembly 420. As noted above, secondary lubricant tank 532 is positioned above second proprotor gearbox so that lubricant is gravity-fed therefrom. If the pressure increases above the threshold or the temperature decreases below the threshold, depending on sensor type, the controller closes the solenoid valve to stop the flow of lubricant to second gearbox assembly 420.

Emergency lubrication system 530 has been described relative to tiltrotor aircraft 101. It will be appreciated by those of skill in the art that emergency lubrication system may be used with other types of aircraft, such as airplanes, helicopters, and the like.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “generally,” and “about” may be substituted with “within [a percentage] of” what is specified, as understood by a person of ordinary skill in the art. For example, within 1%, 2%, 3%, 5%, and 10% of what is specified herein.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

1. An emergency lubrication system comprising:
a lubricant tank coupled to a gearbox of an aircraft;
a passive thermostat coupled between the lubricant tank and the gearbox via a lubricant line;
a conductor coupled between the passive thermostat and the gearbox and configured to conduct heat from the gearbox to the passive thermostat; and
wherein the passive thermostat is configured to open in response to the conductor being exposed to a temperature that exceeds a threshold temperature.

2. The emergency lubrication system of claim 1, wherein:
the lubricant tank comprises an outlet;
the gearbox comprises an inlet configured to receive a lubricant from the outlet; and
the outlet is positioned at a height above the inlet to allow a gravity feed of the lubricant from the lubricant tank to the gearbox.

3. The emergency lubrication system of claim 1, comprising a pump disposed within the lubricant tank and configured to pump a lubricant from the lubricant tank to the gearbox.

4. The emergency lubrication system of claim 1, wherein an end of the lubricant line comprises a jet configured to inject a lubricant into the gearbox.

5. The emergency lubrication system of claim 1, wherein the conductor comprises a metallic wire.

6. The emergency lubrication system of claim 1, wherein the conductor comprises a heat pipe.

7. A lubrication system for an aircraft, the lubrication system comprising:
a primary lubrication system for a gearbox of the aircraft, the primary lubrication system comprising a first lubricant tank;
an emergency lubrication system for the gearbox, the emergency lubrication system comprising:
a second lubricant tank coupled to a gearbox of the aircraft;
a passive thermostat coupled between the second lubricant tank and the gearbox via a lubricant line; and
a conductor coupled between the passive thermostat and the gearbox and configured to conduct heat from the gearbox to the passive thermostat;
wherein the passive thermostat is configured to open in response to the conductor being exposed to a temperature that exceeds a threshold temperature.

8. The lubrication system of claim 7, wherein:
the second lubricant tank comprises an outlet;
the gearbox comprises an inlet configured to receive a lubricant from the outlet; and
the outlet is positioned at a height above the inlet to allow a gravity feed of the lubricant from the second lubricant tank to the gearbox.

9. The lubrication system of claim 7, comprising a pump disposed within the second lubricant tank and configured to pump a lubricant from the second lubricant tank to the gearbox.

10. The lubrication system of claim 7, wherein an end of the lubricant line comprises a jet configured to inject a lubricant into the gearbox.

11. The lubrication system of claim 7, wherein the conductor comprises a metallic wire.

12. The lubrication system of claim 7, wherein the conductor comprises a heat pipe.

13. A method of providing passive emergency lubrication for an aircraft, the method comprising:
conducting heat from a gearbox of the aircraft to a passive thermostat via a conductor that is coupled between the passive thermostat and the gearbox;
responsive to a temperature of the passive thermostat exceeding a threshold temperature, opening the passive thermostat to allow a lubricant to flow from a lubricant tank to the gearbox via a lubricant line; and
providing the lubricant via the lubricant line to the gearbox from the lubricant tank.

14. The method of claim 13, comprising closing the passive thermostat in response to the temperature of the passive thermostat falling below the threshold temperature to prevent the lubricant from flowing from the lubricant tank to the gearbox.

15. The method of claim 13, wherein:
the lubricant tank comprises an outlet;
the gearbox comprises an inlet configured to receive the lubricant from the outlet; and
wherein the lubricant is provided to the gearbox via gravity feed due to the outlet being at a height greater than the inlet.

16. The method of claim 13, wherein the lubricant tank comprises a pump configured to pump lubricant from the lubricant tank to the gearbox.

17. The method of claim 13, wherein the lubricant line comprises a jet that disperses the lubricant into the gearbox.

18. The method of claim 13, wherein the conductor comprises a metallic wire.

19. The method of claim 13, wherein the conductor comprises a heat pipe.
